(19) United States
(12) Patent Application Publication
(10) Pub. No.: US 2016/0173530 A1
(43) Pub. Date: Jun. 16, 2016

(54) Vehicle-Mounted Network System

(71) Applicant: HITACHI AUTOMOTIVE SYSTEMS ,LTD., Hitachinaka-shi ,Ibaraki (JP)

(72) Inventor: Junji MIYAKE, Hitachinaka (JP)

(21) Appl. No.: 14/377,625

(22) PCT Filed: Feb. 13, 2013
(86) PCT No.: PCT/JP2013/053610

§ 371 Date: Aug. 8, 2014

(30) Foreign Application Priority Data
Feb. 16, 2012 (JP) 2012-031787

(51) Int. Cl. H04L 29/06; H04L 29/08

(52) U.S. Cl. CPC H04L 63/20; H04L 63/08; H04L 67/12

(57) ABSTRACT

Provided is a vehicle-mounted network system that enhances security of a vehicle by detecting or eliminating an attack on a vehicle-mounted network from an unauthorized ECU while reducing an increase in a processing load (and cost) of each vehicle-mounted control device.

The vehicle-mounted network system according to the present invention provides a communication protocol issue device having a function of distributing definition data that defines a portion that is based on implementation on the vehicle-mounted network among communication protocols to the vehicle-mounted control device via a registration device that allows the vehicle-mounted control device to register in the vehicle-mounted network.

### TECHNICAL FIELD

The present invention relates to a vehicle-mounted network system.

### BACKGROUND ART

In recent years, a large number of vehicle-mounted ECUs (Electronic Control Unit) for controlling each function unit are mounted on cars, trucks, and buses. The respective ECUs are mutually connected to each other via a vehicle-mounted network to operate in cooperation.

Typically, a control program mounted on a vehicle-mounted ECU is stored in a storage device such as flash ROM (Read Only Memory) of a microcomputer incorporated in the vehicle-mounted ECU. A version of this control program is managed by a manufacturer. The version of this control program is intended such that an independent function and a cooperated function via the vehicle-mounted network operate normally by combining authorized software versions.

Therefore, it cannot be overlooked from a viewpoint of vehicle security that a vehicle-mounted ECU in which unintended software is mounted or a vehicle-mounted ECU falsified intentionally is connected to the vehicle-mounted network.

When such an unauthorized ECU exists in the vehicle-mounted network, because vehicle-mounted ECUs are mutually connected via the vehicle-mounted network (typically connected in a bus configuration), an entire system will be jeopardized. From the viewpoint of security, for example, it is necessary to assume that the vehicle-mounted network will be attacked by the unauthorized ECU.

There are two types of possible attacks on the vehicle-mounted network. A first attack is a denial-of-service (DoS) attack on the vehicle-mounted network from the unauthorized ECU. The DoS attack mainly refers to transmission of a large amount of connection requests to a server on the Internet to reduce a line speed or to cause the network to go down by an overload. For the vehicle-mounted network, the DoS attack refers to an action of inhibiting communication between authorized ECUs by congestion (concentration of traffic) and interfering real-time control by an increase in delay time.

A second possible attack is wiretapping of communication contents. This also includes wiretapping the vehicle-mounted network, stealing technical information, and attempting to perform unintended control using the information via the vehicle-mounted network.

In order to overcome these weak points in security for the vehicle-mounted network, a technique of detecting the above-mentioned attack is needed. The following PTL 1 describes a technique of sharing a common key or a common key generation source among a plurality of vehicle-mounted ECUs and keeping communication confidential by encrypted communication among authorized ECUs that are estimated to share this information.

### CITATION LIST

### Patent Literature

PTL 1: JP 2010-11400 A

### SUMMARY OF INVENTION

### Technical Problem

The technique described in the above-mentioned PTL 1 only keeps communication confidential by the encrypted communication using the common key. It is difficult to detect the DoS attack from the unauthorized ECU and wiretapping by the unauthorized ECU on the vehicle-mounted network.

In addition, because the technique described in PTL 1 performs encrypted communication by the common key among vehicle-mounted ECUs, a great deal of computer power is necessary for implementing the encrypted communication. That is, a calculation resource for restoring a key of a communication partner based on a KPS (Key Predistribution System) method cited in PTL 1 and a calculation resource for performing common key encryption, such as a DES (Data Encryption Standard) method that performs encrypted communication with the key are necessary.

Such processing requires an extremely large resource for capability (computation capability of a CPU, capacity of ROM/RAM, etc.) of the current vehicle-mounted ECU. Therefore, in order to achieve the encrypted communication described in PTL 1, an increase in cost of the vehicle-mounted ECU is unavoidable. In addition, when the above-mentioned method is implemented without enhancing hardware performance, a significant drop in a processing speed is expected in real-time processing, thus it is difficult to serve as the vehicle-mounted ECU.

When the current vehicle-mounted ECU is designed, cost reduction of each ECU and a component of the ECU are accumulated to adjust a price strategy for the entire vehicle system. For a purpose of the encrypted communication among vehicle-mounted ECUs, a price increase of these components is not acceptable at all.

The present invention has been made to solve the above-described problems, and an object of the present invention is to enhance security of a vehicle by detecting or eliminating an attack on a vehicle-mounted network from an unauthorized ECU while reducing an increase in a processing load (and cost) of each vehicle-mounted control device.

### Solution to Problem

The vehicle-mounted network system according to the present invention provides a communication protocol issue device having a function of distributing definition data that defines a portion that is based on implementation on the vehicle-mounted network among communication protocols to the vehicle-mounted control device via a registration device that allows the vehicle-mounted control device to register in the vehicle-mounted network.

### Advantageous Effects of Invention

The vehicle-mounted network system according to the present invention can specify entire operation of the vehicle-mounted network by a communication protocol specific to each vehicle, detect that an unauthorized ECU is connected to the vehicle-mounted network, or prevent the unauthorized ECU from interpreting data that is intercepted without permission, the unauthorized ECU being unaware that the entire operation of the vehicle-mounted network is specified by the communication protocol specific to each vehicle. Among communication protocols, processing for changing a portion that is based on implementation does not need a great deal of processing load, and therefore it is not necessary to add a hardware resource to each ECU. In addition, by distributing the specific communication protocol via the authenticated registration device, it is possible to secure advanced reliability (protocol falsification prevention). This makes it possible to enhance security of the entire vehicle-mounted network while reducing the processing load and cost of each vehicle-mounted control device.

### BRIEF DESCRIPTION OF DRAWINGS

FIG. 1 is a configuration diagram of a vehicle-mounted network system 1000 according to a first embodiment.

FIG. 2 is a diagram illustrating a sequence in which a communication protocol issue device 103 authenticates a network registration device 102.

FIG. 3 is a diagram illustrating a method of detecting an ECU that is illegally connected to a vehicle-mounted network and launches a DoS attack.

FIG. 4 illustrates a sequence described in FIG. 3 as a processing flow of the communication protocol issue device 103.

FIG. 5 is a diagram illustrating a method of detecting an ECU that illegally wiretaps data flowing through the vehicle-mounted network.

FIG. 6 illustrates a sequence described in FIG. 5 as a processing flow of the communication protocol issue device 103.

FIG. 7 is a diagram illustrating a configuration example of a vehicle-mounted network described in PTL 1.

FIG. 8 is a diagram illustrating a configuration example of the vehicle-mounted network system 1000 according to a second embodiment.

FIG. 9 is a diagram illustrating a principle of obfuscation of a data frame that flows through the vehicle-mounted network 202 in the present invention.

FIG. 10 is a diagram illustrating a structure of a “vehicle-specific protocol” that the communication protocol issue device 103 distributes to a target ECU 101 in step S113 of FIG. 1.

FIG. 11 is a diagram illustrating an example of a network topology of a vehicle-mounted network provided in a recent representative sophisticated vehicle.

### DESCRIPTION OF EMBODIMENTS

### First Embodiment

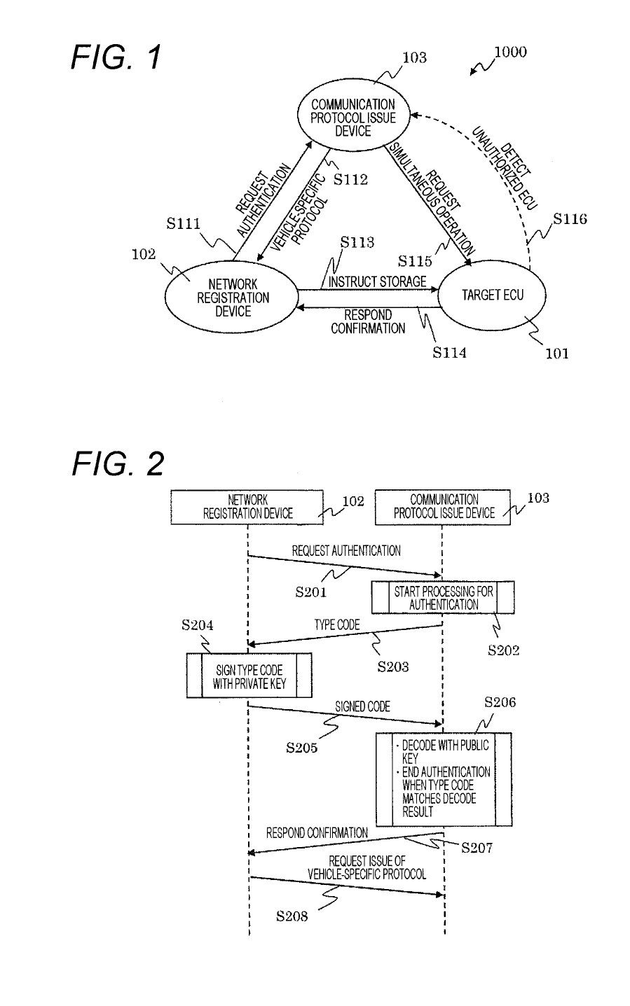

FIG. 1 is a configuration diagram of a vehicle-mounted network system 1000 according to a first embodiment of the present invention. The vehicle-mounted network system 1000 is an in-vehicle network connecting ECUs that control operation of a vehicle. Herein, only a target ECU 101 to which a vehicle-specific protocol is to be distributed is illustrated by way of example, but a number of ECUs to be connected to the vehicle-mounted network system 1000 is not limited to this example.

The vehicle-mounted network system 1000 is connected with the target ECU 101 and a communication protocol issue device 103 via a vehicle-mounted network. In addition, in order to allow the target ECU 101 to register participation in the vehicle-mounted network, a network registration device 102 is connected to the vehicle-mounted network system 1000 as needed.

The network registration device 102 is a device for allowing the target ECU 101 to participate in the vehicle-mounted network. Allowing the target ECU 101 to participate in the vehicle-mounted network refers to allowing the vehicle-specific protocol that the communication protocol issue device 103 issues only to an authorized ECU in the vehicle-mounted network to be stored in a memory included in the target ECU 101, and allowing the target ECU 101 to communicate on the vehicle-mounted network using the vehicle-specific protocol from this time.

In order to perform network registration processing on the target ECU 101, the network registration device 102 needs to be previously authenticated by the communication protocol issue device 103. Authentication described herein is processing of verifying whether the network registration device 102 has authority to allow the target ECU 101 to participate in the vehicle-mounted network.

The network registration device 102 does not necessarily need to be always connected to the vehicle-mounted network. For example, when the vehicle-mounted network system 1000 is built in a vehicle-manufacturing process, it is possible to manually connect the network registration device 102 to the vehicle-mounted network only when performing work of allowing the target ECU 101 to participate in the vehicle-mounted network.

The communication protocol issue device 103 is a device capable of communicating with the target ECU 101 and the network registration device 102 via the vehicle-mounted network. The communication protocol issue device 103 issues the above-mentioned vehicle-specific protocol and distributes the vehicle-specific protocol to the target ECU 101 via the network registration device 102. The vehicle-specific protocol described herein defines, among communication protocols used on the vehicle-mounted network, a portion that is based on implementation of the vehicle-mounted network. A specific example will be described in a second embodiment to be described later. The communication protocol issue device 103 may be configured as one type of ECU or may be configured as other arbitrary communication device.

FIG. 1 is a diagram illustrating a procedure in which the network registration device 102 allows the target ECU 101 to participate in the vehicle-mounted network. The following describes each step of FIG. 1.

(FIG. 1: Step S111: Request Authentication)

An operator operates the network registration device 102 to start the work (registration processing) of allowing the target ECU 101 to participate in the vehicle-mounted network. After the registration processing starts, the network registration device 102 requests the communication protocol issue device 103 to authenticate the network registration device 102 via the vehicle-mounted network.

(FIG. 1: Step S112: Distribute the Vehicle-Specific Protocol)

When receiving the authentication request from the network registration device 102, the communication protocol issue device 103 authenticates the network registration device 102 in accordance with a predetermined authentication algorithm (details will be described later in FIG. 2). When authenticity of the network registration device 102 is confirmed, the communication protocol issue device 103 generates definition data that defines the vehicle-specific protocol to be kept confidential from outside the vehicle, and distributes the definition data to the network registration device 102.

(FIG. 1: Step S113: Instruct to Store the Protocol)

The network registration device 102 relays the definition data distributed from the communication protocol issue device 103 to the target ECU 101 that is to be allowed to participate in the vehicle-mounted network. The network registration device 102 then instructs the target ECU 101 to store the definition data in the memory.

(FIG. 1: Step S114: Notify Storage Completion)

The target ECU 101 stores, in the memory of the target ECU 101, the definition data received in step S113 and notifies the network registration device 102 that the target ECU 101 has normally participated in the vehicle-mounted network.

(FIG. 1: Step S115: Request Simultaneous Operation)

The communication protocol issue device 103 broadcasts a simultaneous operation request to the vehicle-mounted network based on estimation that “the vehicle-specific protocol distributed via the network registration device 102 in step S112 is shared among all the authorized ECUs”. Based on this instruction, the target ECU 101 communicates with the vehicle-mounted network in accordance with the definition data received in step S113.

(FIG. 1: Step S116: Detect Unauthorized ECU)

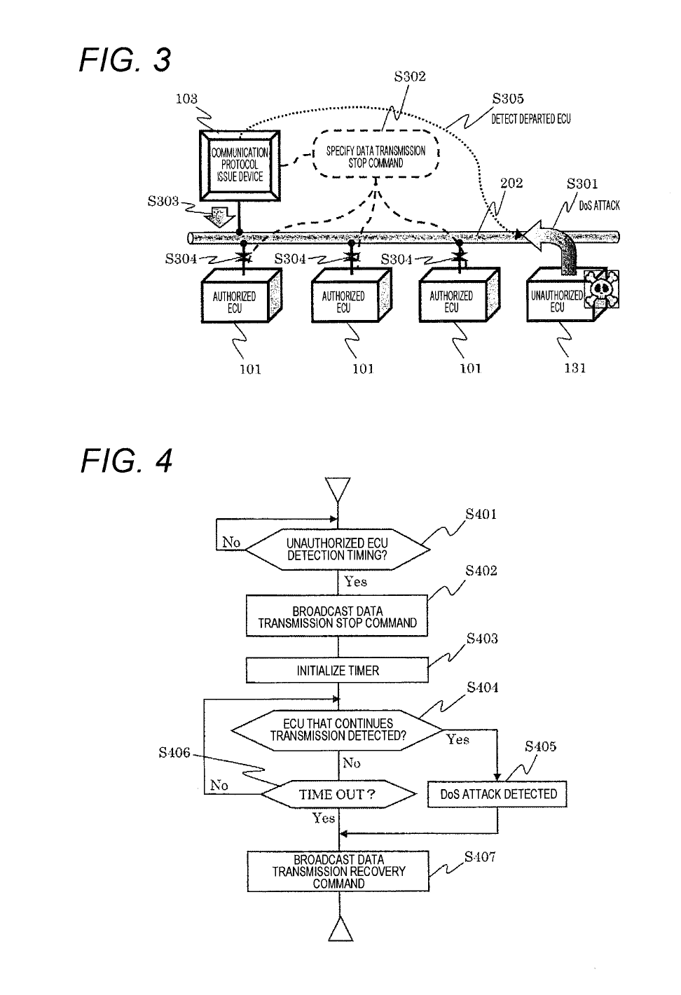

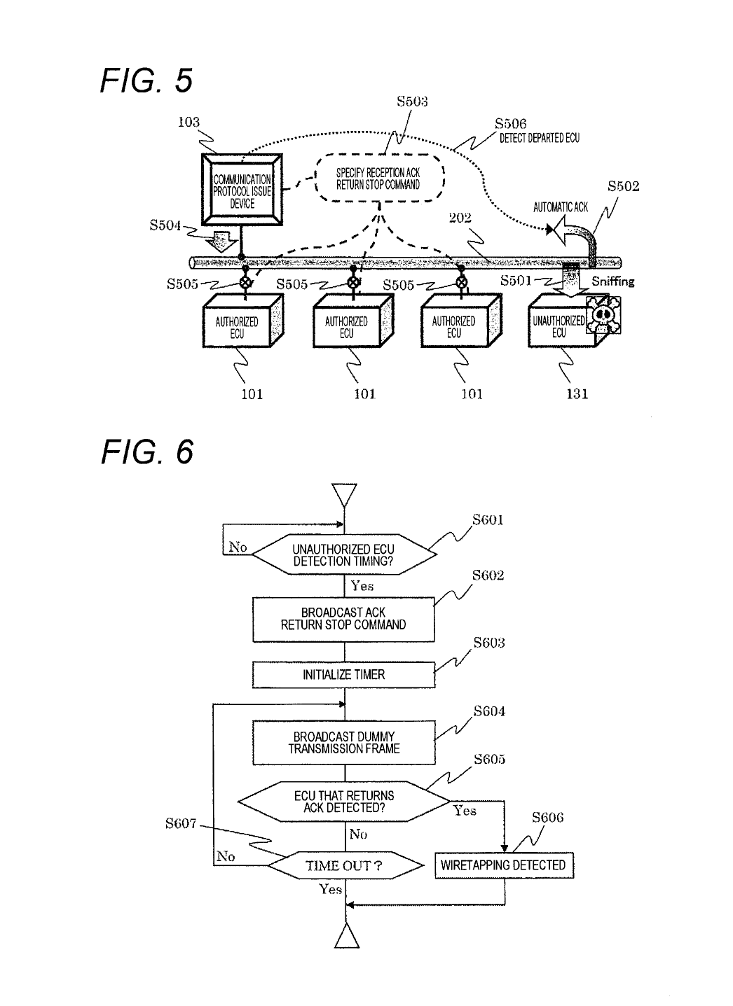

The communication protocol issue device 103 finds an ECU that does not comply with the simultaneous operation request (step S115). As will be described later in FIG. 3 and FIG. 5, because this ECU is likely to be an unauthorized ECU that attempts to do damage to the vehicle-mounted network, the communication protocol issue device 103 stores this information and originates an alarm about the unauthorized ECU to outside.

### First Embodiment

### Authenticate the Network Registration Device

FIG. 2 is a diagram illustrating a sequence in which the communication protocol issue device 103 authenticates the network registration device 102. This authentication is a core of reliability of the present invention. The authentication sequence of FIG. 2 corresponds to step S111 of FIG. 1. There is described herein a method of authenticating the network registration device 102 using a digital signature based on a public key encryption system by way of example, but another authentication system, such as challenge and response authentication, can also be employed. Incidentally, it is assumed that a pair of public key and private key for the network registration device 102 is previously generated and that the public key is previously distributed to the communication protocol issue device 103. The following describes each step of FIG. 2.

(FIG. 2: Step S201)

The network registration device 102 requests the communication protocol issue device 103 to authenticate that the network registration device 102 is an authorized terminal before operation of registering the target ECU 101 in the network, such as, for example, when being first connected to the vehicle-mounted network. At this time, an identification code (or similar information) of the network registration device 102 is transmitted together to demonstrate the information that uniquely identifies the network registration device 102 to the communication protocol issue device 103.

(FIG. 2: Step S201: Supplement)

The authorized terminal described in the present step refers to a terminal that is ensured in that the network registration device 102 is authorized by a manufacturer of the vehicle, that the network registration device 102 has authority to register participation of the target ECU 101 in the vehicle-mounted network, that the network registration device 102 is not falsified, and that the authorized network registration device 102 is not spoofed by another device.

(FIG. 2: Steps S202 to S203)

The communication protocol issue device 103 performs authentication start processing (S202). Specifically, the communication protocol issue device 103 generates a type code by using a pseudorandom number and returns the type code to the network registration device 102 (S203). In addition, the communication protocol issue device 103 uses the identification code received from the network registration device 102 in step S201 to specify the public key corresponding to the network registration device 102.

(FIG. 2: Steps S204 to S205)

The network registration device 102 signs (S204), by the private key of the network registration device 102, the type code received from the authentication server in step S203 and returns the type code as a signed code to the communication protocol issue device 103 (S205).

(FIG. 2: Step S206)

The communication protocol issue device 103 reads the public key specified in step S202 and uses the public key to decode the signed code received from the network registration device 102 in step S205. The communication protocol issue device 103 compares a decode result with the type code transmitted to the network registration device 102 in step S203, and when both match, determines that the network registration device 102 is an authorized terminal. When both do not match, the network registration device 102 is not authenticated.

(FIG. 2: Steps S207 to S208)

The communication protocol issue device 103 transmits, as a confirmation response, a fact that the authentication sequence ends to the network registration device 102 (S207). Subsequently, the network registration device 102 requests the communication protocol issue device 103 to issue a vehicle-specific protocol that is to be relayed to the target ECU 101 that is to be allowed to register participation in the vehicle-mounted network from this time (S208).

### First Embodiment

### Detect DoS-Attacking ECU

FIG. 3 is a diagram illustrating a method of detecting an ECU that is illegally connected to the vehicle-mounted network and launches a DoS attack. When detecting an unauthorized ECU 131 that launches the DoS attack, after distributing the vehicle-specific protocol in step S112, the communication protocol issue device 103 distributes a data transmission stop command for ordering to stop data transmission to the vehicle-mounted network 202. An ECU that does not comply with the data transmission stop command, which properly speaking must reduce a traffic volume of the vehicle-mounted network 202, maintains or increases the traffic volume. Accordingly, it is possible to estimate that the ECU is performing the DoS attack. The following describes each step illustrated in FIG. 3.

It is assumed in FIG. 3 that the unauthorized ECU 131 launches the DoS attack on the vehicle-mounted network 202 (S301). That is, the unauthorized ECU (131) regularly injects meaningless traffic into the vehicle-mounted network 202 for a purpose of interfering with communication among authorized ECUs.

It is assumed that the above-mentioned “data transmission stop command” is specified and shared (S302) between the communication protocol issue device 103 and the target ECU 101 (notated as the authorized ECU 101 in FIG. 3 for convenience) in conformity with the vehicle-specific protocol. The “data transmission stop command”, which is issued in accordance with the vehicle-specific protocol distributed in step S112 of FIG. 1, is information that is secretly shared only among authorized ECUs 101 connected to the vehicle-mounted network 202, and that is not opened to outside the vehicle. Therefore, the command is not known to the unauthorized ECU 131.

The communication protocol issue device 103 simultaneously transmits the “data transmission stop command” to the vehicle-mounted network 202 in a specific driving mode of the vehicle (for example, during ignition key OFF with little influence on vehicle control and a maintenance mode in a service factory, etc.)(S303).

The authorized ECU 101 simultaneously stops the data transmission to the vehicle-mounted network 202 in accordance with the “data transmission stop command” transmitted by the communication protocol issue device 103 (S304). However, because the transmission of only data voluntarily sent from the authorized ECU 101 needs to be stopped, an ACK response to data received by the authorized ECU 101 may be continuously transmitted.

The unauthorized ECU 131, which has not received the vehicle-specific protocol distributed by the network registration device 101, cannot interpret the “data transmission stop command”. Therefore, the unauthorized ECU 131 continues to transmit interference traffic. The communication protocol issue device 103 recognizes that the vehicle-mounted network 202 is under the DoS attack by detecting this departure from cooperation (S305).

FIG. 4 illustrates a sequence described in FIG. 3 as a processing flow of the communication protocol issue device 103. The following describes each step of FIG. 4.

(FIG. 4: Step S401)

The communication protocol issue device 103 determines whether current timing is suitable for detecting the unauthorized ECU. This corresponds to determination of whether the current timing is in the specific driving mode of the vehicle described in FIG. 3 (for example, during ignition key OFF with little influence on vehicle control and a maintenance mode in a service factory, etc.) Detection of the unauthorized ECU is an active (it is not passive, nondestructive measurement such as monitoring) measurement that is performed by causing the vehicle-mounted network to make a transition to a state different from a usual state. Thus, the detection may be performed only at timing when vehicle control may be lost for a predetermined period to consider safety. Accordingly, it will be determined in the present step whether the current timing is suitable for detecting the unauthorized ECU. When the current timing is suitable for detecting the unauthorized ECU, the processing goes to step S402. Otherwise, the processing waits in the present step.

(FIG. 4: Steps S402 to S403)

The communication protocol issue device 103 broadcasts the “data transmission stop command” described in FIG. 3 to the vehicle-mounted network 202 to simultaneously stop the data transmission from the authorized ECU (S402). The communication protocol issue device 103 also initializes a timer for measurement (S403).

(FIG. 4: Step S404)

The communication protocol issue device 103 checks whether there is an ECU that continues transmission although the transmission is simultaneously stopped. When there is an ECU that continues transmission, the processing goes to step S405, from consideration that the network is under the DoS attack. When an ECU that continues transmission is not detected, the processing goes to step S406.

(FIG. 4: Step S405)

The communication protocol issue device 103 records detection of the DoS attack in a memory, etc. and originates an alarm about the detection at a suitable later time.

(FIG. 4: Step S406)

The communication protocol issue device 103 checks whether a timeout has occurred in the timer for measurement that is set in step S403. When the timeout has not occurred, the processing returns to step S404 and repeats similar processing. When the timeout has occurred, the processing goes to step S407.

(FIG. 4: Step S407)

The communication protocol issue device 103 broadcasts a “data transmission recovery command”, causes the vehicle-mounted network 202 to return to a normal state, and ends the present processing flow. A normal ECU 101 that receives the “data transmission recovery command” returns to a state before receiving the “data transmission stop command”.

### First Embodiment

### Detect Wiretapping ECU

FIG. 5 is a diagram illustrating a method of detecting an ECU that illegally wiretaps data flowing through the vehicle-mounted network. When detecting an unauthorized ECU 131 that launches wiretapping, after distributing the vehicle-specific protocol in step S112, the communication protocol issue device 103 distributes a reception ACK return stop command for ordering to stop returning an ACK (ACKnowledgement) signal when data is received. The ACK signal is a response signal used for reception confirmation in an automatic resending protocol of the vehicle-mounted network.

Many communication protocols often used in the vehicle-mounted network, such as CAN (Controller Area Network), have a mechanism for resending data automatically. In each of the communication protocols having this mechanism, a node that normally receives data returns the ACK signal to a transmitting node. The transmitting node automatically resends the data on an assumption that the data is lost en route until the ACK signal is returned. This is a protocol that achieves a kind of handshake and is a typical method for improving reliability of data communication.

In FIG. 5, it is assumed that the unauthorized ECU 131 wiretaps the vehicle-mounted network 202 (S501). It is assumed that the unauthorized ECU 131 returns the ACK signal to a data frame flowing through the vehicle-mounted network 202 in a same manner as the authorized ECU 101, and is urging to advance data transmission (S502).

It is assumed that the above-mentioned “reception ACK return stop command” is specified and shared in conformity with the vehicle-specific protocol between the communication protocol issue device 103 and the authorized ECU 101 (S503). The “reception ACK return stop command”, which is issued in accordance with the vehicle-specific protocol distributed in step S112 of FIG. 1, is information that is secretly shared only among the authorized ECUs 101 connected to the vehicle-mounted network 202, and is not opened to outside the vehicle. Therefore, the “reception ACK return stop command” is not known to the unauthorized ECU 131.

The communication protocol issue device 103 simultaneously transmits the above-mentioned “reception ACK return stop command” to the vehicle-mounted network 202 in the specific driving mode of the vehicle (for example, during ignition key OFF with little influence on vehicle control and a maintenance mode in a service factory, etc.)(S504).

The authorized ECU 101 simultaneously stops the data transmission to the vehicle-mounted network 202 in accordance with the “reception ACK return stop command” transmitted by the communication protocol issue device 103 (S505). In order to stop ACK return, for example, a communication device and communication driver (not illustrated) in each authorized ECU 101 may be separated from the vehicle-mounted network 202 during a predetermined period previously agreed by the entire vehicle-mounted network system 1000. This prevents the authorized ECU 101 from transmitting communication data, resulting in failure to return the ACK signal.

After distributing the “reception ACK return stop command”, the communication protocol issue device 103 transmits a suitable dummy data frame to the vehicle-mounted network 202. The unauthorized ECU 131, which participates in the network without distribution of the vehicle-specific protocol distributed from the network registration device 102, cannot interpret the “reception ACK return stop command”. Accordingly, the unauthorized ECU 131 returns the ACK signal to the dummy data frame. By detecting this departure from cooperation, the communication protocol issue device 103 recognizes that there is the unauthorized ECU 131 that wiretaps the vehicle-mounted network 202 (S506).

FIG. 6 illustrates a sequence described in FIG. 5 as a processing flow of the communication protocol issue device 103. The following describes each step of FIG. 6.

(FIG. 6: Steps S601 to S603)

Step S601 is similar to S401. In step S602, the communication protocol issue device 103 broadcasts the “reception ACK return stop command” described in FIG. 5 to the vehicle-mounted network 202 to separate the authorized ECU 101 from the vehicle-mounted network 202. However, this operation has a time limit. Each authorized ECU 101 is reconnected to the original vehicle-mounted network 202 after predetermined time to prevent a deadlock. In step S603, the communication protocol issue device 103 initializes the timer for measurement as in S403. A timeout (wiretapping measuring time) of this timer for measurement is smaller than the time limit triggered by step S602 for separation of the authorized ECU from the vehicle-mounted network.

(FIG. 6: Steps S604 to S605)

In order to check whether return of the reception ACK has been stopped, the communication protocol issue device 103 broadcasts a dummy transmission frame to the vehicle-mounted network 202 (S604). The communication protocol issue device 103 checks whether there is an ECU that returns the ACK signal in response to the dummy transmission frame of step S604 although returning the reception ACK has been stopped (S605). When there is an ECU that returns the ACK signal, the processing goes to step S606. When there is no ECU that returns the ACK signal, the processing goes to step S607.

(FIG. 6: Step S606)

The communication protocol issue device 103 records detection of wiretapping in a memory, etc. and originates an alarm about the detection at a suitable later time.

(FIG. 6: Step S607)

The communication protocol issue device 103 checks whether the timeout has occurred in the timer for measurement that is set in step S603. When the timeout has not occurred, the processing returns to step S604 and repeats similar processing. When the timeout has occurred, the communication protocol issue device 103 ends the present processing flow.

(FIG. 6: Supplement after Step S606 or Step 607)

Because the “reception ACK return stop command” distributed in step S602 has a time limit, the authorized ECU 101 is autonomously reconnected to the vehicle-mounted network 202 after the time limit. Therefore, it is not necessary to explicitly provide a step corresponding to step S407.

### First Embodiment

### Summary

As described above, in the vehicle-mounted network system 1000 according to the first embodiment, the communication protocol issue device 103 can distribute the vehicle-specific protocol to the target ECU 101 via the network registration device 102 whose authenticity can be strictly verified. This allows detection of a DoS attack and wiretapping without consuming a great deal of calculation resources and increasing current ECU costs.

### Second Embodiment

A second embodiment of the present invention describes a specific configuration example of a vehicle-mounted network system 1000 described in the first embodiment. In addition, the second embodiment describes a function of not only detecting an unauthorized ECU 131 but also obfuscating communication data by a vehicle-specific protocol.

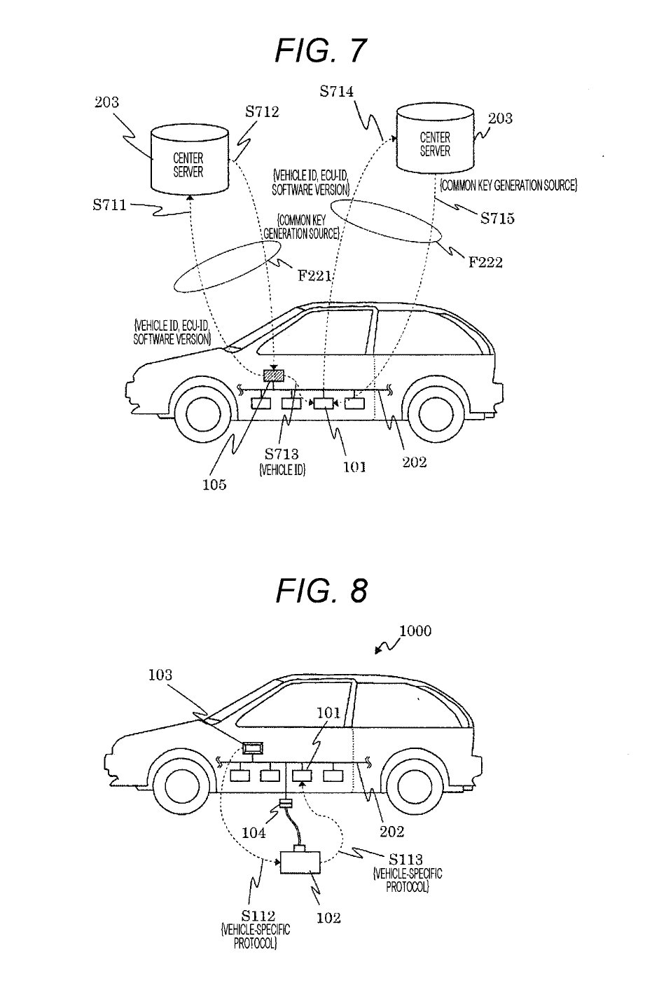

The following compares the vehicle-mounted network system 1000 (FIG. 8) according to the second embodiment with a conventional example (FIG. 7) described in PTL 1, and describes a difference regarding a physical configuration and details of processing.

### Second Embodiment

### Describe the Conventional Example

FIG. 7 is a diagram illustrating a configuration example of a vehicle-mounted network described in PTL 1. FIG. 7 is described for comparison with the second embodiment. In FIG. 7, an ECU master 105 exists in a vehicle-mounted network 202. The ECU master 105 retains an identification number {vehicle ID} for each vehicle.

When performing initialization processing, the ECU master 105 makes a set of pieces of information about {vehicle ID, ECU-ID, and software version} and requests a center server 203 installed outside the vehicle-mounted network 202 to distribute a {common key generation source} (step S711). The ECU-ID is an identifier of the ECU master 105. The software version is a version of software mounted in the ECU master 105.

In response to the request, the center server 203 distributes the {common key generation source} (step S712). These exchanges are encrypted with an initialization key that is fixedly set within the ECU master 105 (external communication F221).

The {common key generation source} distributed from the center server 203 is “information source for deriving a common key” used only for communication among ECUs that belong to the vehicle-mounted network 202. The {common key generation source} is not used during communication with the center server 203.

A target ECU 101 that belongs to the vehicle-mounted network other than the ECU master 105 obtains the {vehicle ID} from the ECU master 105. Because the target ECU 101 has not obtained the {common key generation source} at this time, the target ECU 101 communicates with the ECU master 105 without performing encryption (step S713).

The target ECU 101 uses the {vehicle ID} received from the ECU master 105 to assemble a set of {vehicle ID, ECU-ID, and software version}. The target ECU 101 requests the center server 203 to distribute the {common key generation source} (step S714). The ECU-ID is an identifier of the target ECU 101. The software version is a version of software mounted in the target ECU 101.

In response to the request, the center server 203 distributes the {common key generation source} (step S715). These exchanges are encrypted with an initialization key that is fixedly set within the target ECU 101 (external communication F222).

From the above configuration, it will be apparent that the following vulnerability exists in the system in PTL 1.

(Vulnerability 1) When performing the initialization processing, all the ECUs that belong to the vehicle-mounted network 202 are connected to the center server 203 disposed outside the vehicle-mounted network 202 to receive distribution of the {common key generation source}. Therefore, when connection with the center server 203 is severed during the initialization processing, it is not possible to configure a valid vehicle-mounted network.

(Vulnerability 2) The center server 203 manages sets of {vehicle ID, ECU-ID, and software version} and {common key generation source} of all the vehicles. Therefore, when the center server 203 is illegally invaded, keys for all the vehicles will be drained. In addition, occurrence of a trouble in the center server 203, regardless of intentionally or due to negligence, involves danger that the keys for all the vehicles are lost.

(Vulnerability 3) Encrypted communication (external communication F221 and external communication F222) when performing the initialization processing is vulnerable. Therefore, when receiving distribution of the {common key generation source}, mutual authentication between the ECU and the center server 203 is not secure. This results from a property that an encryption key that is fixed and has few variations must be used under a constraint of ECU hardware that is mass-produced as a component. Accordingly, when this encryption key is broken, regarding the center server 203, there is a possibility that key information about a specific vehicle is drained. Regarding the vehicle-mounted ECU, there is a possibility that interference in the vehicle-mounted network, etc. occurs by a malicious third party distributing false key information.

(Vulnerability 4) Because a flow of the {vehicle ID} (step S313) between the ECU master 105 and the target ECU 101 at a time of performing the initialization processing is not encrypted, it is possible to easily capture the {vehicle ID} from outside the vehicle-mounted network 202. This will be a clue for the malicious third party to guess the set of {vehicle ID, ECU-ID, and software version} (used in step S311 and step S314).

In addition, because communication is performed among ECUs using a common key encryption system, there are system problems described below.

(Problem 1) Because the common key with a communication partner ECU is derived by specific arithmetic from the {common key generation source} (this common key differs depending on the communication partner ECU), arithmetic processing time is needed for deriving this key. Moreover, even in common key encrypted communication, in addition to original control processing, additional processing time is needed to perform its encryption and decryption, thus real time properties are damaged by an increase in the processing time.

(Problem 2) The common key encryption system has poor communication efficiency. When a signal to be encrypted is short, in order to protect encrypted communication from a brute-force attack, the signal is padded until the signal has a certain message length. This will cause lower communication efficiency, and an amount of communication information per unit time drops.

(Problem 3) The use of the common key encryption system for real-time-control data communication itself is overdesigned. The common key encryption system is devised in order to encrypt a message (meaning of which can be understood upon reading) used by a human. An essential point of the system is how to scramble a plain text in order to avoid a dictionary attack. In contrast, the real-time-control data communication does not use a message that a human reads and finds meaning (for example, A/D conversion value, etc.). Therefore, it seems that only a change of shifting or exchanging a position of specific data mapping in a communication data frame, etc. independently in individual vehicle will have a sufficient effect on obfuscating the data frame.

### Second Embodiment

### Describe the Present Invention

FIG. 8 is a diagram illustrating a configuration example of the vehicle-mounted network system 1000 according to the second embodiment. A communication protocol issue device 103 is installed in the vehicle-mounted network 202. A procedure of allowing a new target ECU 101 to participate in the vehicle-mounted network 202 will be described in detail.

An operator connects a network registration device 102 to a connection vehicle connector 104. The network registration device 102 communicates with the communication protocol issue device 103 to be authenticated. At this time, the operator inputs, in the network registration device 102, ECUI-ID, etc. of the target ECU 101 that is to be allowed to participate in the vehicle-mounted network 202 from this time, and transmits the inputted ECU-ID, etc. to the communication protocol issue device 103. This procedure corresponds to step S111 of FIG. 1.

The communication protocol issue device 103 strictly examines and verifies authenticity of the network registration device 102. Upon confirmation that the network registration device 102 is an authorized device, the communication protocol issue device 103 issues the {vehicle-specific protocol} to be shared by the target ECU 101 to be connected to the network from this time (step S112).

The network registration device 102 relays the {vehicle-specific protocol} to the target ECU 101 to cause the target ECU 101 to store the protocol (step S113). By following the above procedure, the {vehicle-specific protocol} is safely shared between the communication protocol issue device 103 and the target ECU 101 (authorized ECU to participate in the vehicle-mounted network 202).

The vulnerability in the conventional examples described above will be improved as follows by a mechanism of the present invention described above. Improvements corresponding to the vulnerability described above will be described in order identical to order of the vulnerability.

(Improvement of the vulnerability 1) Communication performed by each ECU is closed within the vehicle-mounted network 202. Communication with outside the vehicle is not performed. Accordingly, there is little opportunity that the vehicle-mounted network 202 is illegally invaded or generates information leakage.

(Improvement of the vulnerability 2) The communication protocol issue device 103 incorporated in each vehicle manages protocol information in the vehicle-mounted network 202. Accordingly, vulnerability generated by the center server 203 collectively managing the information about all the vehicles does not exist. In addition, the {vehicle-specific protocol} is independent and unique to each vehicle. Even if the {vehicle-specific protocol} is drained, a security pending matter for other vehicles does not occur.

(Improvement of the vulnerability 3) Issue and relay of the {vehicle-specific protocol} when performing the initialization processing are performed between the communication protocol issue device 103 and the network registration device 102, between which strict mutual authentication is performed. Accordingly, a security risk such as interference by a malicious third party is small.

(Improvement of the vulnerability 4) In the present invention, it is unnecessary to exchange, among the ECUs, identification information about the ECU that constitutes members of the vehicle-mounted network 202, for example, {vehicle ID, ECU-ID, and software version}. Accordingly, it is unnecessary to disclose these pieces of identification information to other ECUs via the vehicle-mounted network 202. Therefore, the vehicle-mounted network system 1000 is robust against a leakage risk of these pieces of information.

In addition, the system problems of the known example based on the common key encryption system have been solved as follows.

(Improvement of the problem 1) Because the data frame is obfuscated by changing a communication protocol for each vehicle-mounted network, common key encryption is not used. Therefore, processing time required for common key derivation and processing time required for encryption and decryption are unnecessary.

(Improvement of the problem 2) The method according to the present invention does not lower the communication efficiency. That is, a proportion of original transmission data to an amount of information transmission per time does not drop by padding that is needed in the common key encryption system.

(Improvement of the problem 3) From a viewpoint of interfering communication interception or obfuscating the data frame, it can be said that the method according to the present invention is suitable for real-time-control communication, easy to implement, and well-balanced. That is, because only a transmission ID, a data packing sequence, a flag position, etc. are changed for each vehicle in data communication that serves as a base, the method according to the present invention does not produce an increase in processing loads of a CPU and does not require any additional computer resources such as ROM/RAM.

### Second Embodiment

### Summary of a Principle of Obfuscation

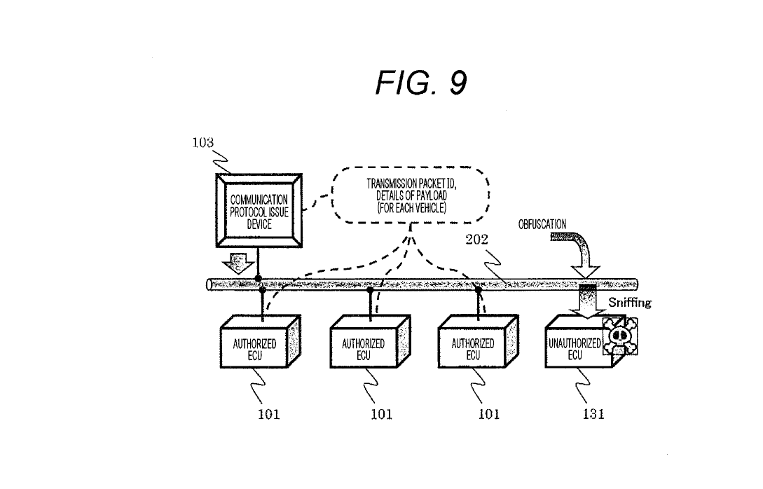

FIG. 9 is a diagram illustrating a principle of obfuscating the data frame that flows through the vehicle-mounted network 202 in the present invention. The communication protocol issue device 103 may define a portion that is based on implementation in the vehicle-mounted network 202, such as an ID of a transmission packet, a size of a payload portion, data arrangement within the payload, etc. in the “vehicle-specific protocol” distributed to the target ECU 101 in step S113 of FIG. 1.

This definition is information shared only between the communication protocol issue device 103 and the authorized ECU 101. An external apparatus fails to obtain the definition because the definition is kept confidential from outside. Therefore, even if an unauthorized ECU 131 that is illegally connected from outside intercepts data communication flowing through the vehicle-mounted network 202, the unauthorized ECU 131 cannot decode meaning of the data because interpretation of the data differs from vehicle to vehicle. That is, it is possible to obfuscate communication data without using an arithmetic algorithm such as encryption.

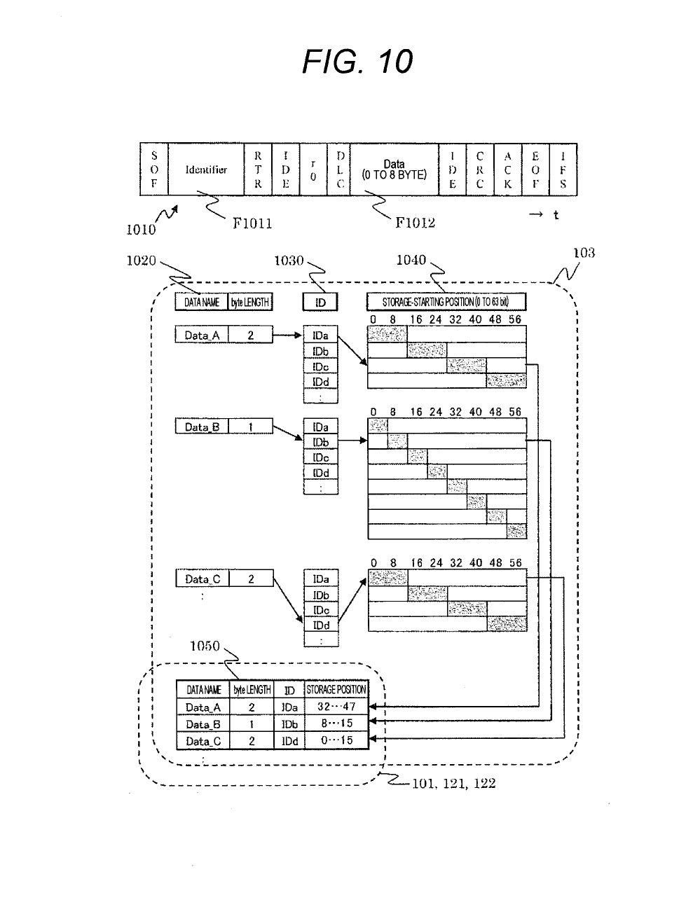

FIG. 10 is a diagram illustrating a structure of the “vehicle-specific protocol” distributed from the communication protocol issue device 103 to the target ECU 101 in step S113 of FIG. 1. FIG. 10 illustrates a data frame 1010 of CAN as an example.

A typical data frame for vehicle-mounted networks specifies a transmission ID (F1011) for identifying a type of the frame and a data-storing portion (F1012). The data frame in a CAN system is also similar as illustrated in FIG. 10. A correspondence between these two attributes (ID for identifying data and a data-storing position) and a semantic data name 1020 used in vehicle control is based on implementation on the vehicle-mounted network 202. The “vehicle-specific protocol” is definition data that specifies the above correspondence.

By secretly sharing this definition data between the communication protocol issue device 103 and the target ECU 101, it is possible to configure a communication protocol that is specific to the vehicle-mounted network 202. The correspondence about both attributes may be changed by the definition data. The correspondence about only one of the attributes may be changed.

FIG. 10 assumes, as the data name 1020, a combination of data names (control variable names) such as, for example, an engine speed, a water temperature, and a diagnostic command, and a data length occupied in a memory for retaining a value of the variable. However, these are only one example of variable attributes. The data name 1020 is not limited to this example.

A “vehicle-specific protocol table” (1050) in the present invention is a table that associates and describes, in a table format, definition (1030) of a correspondence between the data name 1020 and the ID (F1011), and definition (1040) of a correspondence between the data name 1020 and a data-starting position in the data-storing portion (F1012).

When the communication protocol issue device 103 generates the “vehicle-specific protocol table” 1050, it is important from a security viewpoint to use a value such as a random number or a value generated by processing a vehicle identification number (a number assigned uniquely to each produced vehicle) by a hash function to make it difficult to reproduce (analogize) the above correspondence. For example, from among ID candidates that can be associated with the data name 1020, any one of the candidates may be selected by using the hash function, etc. as described above. Because this makes it difficult to guess a selection process, it is possible to increase a degree of obfuscation.

The “vehicle-specific protocol table” 1050 may describe only a data item that has an association with the recipient target ECU 101. For example, the communication protocol issue device 103 may distribute a subset created by extracting only a portion that has an association with the target ECU 101 from the “vehicle-specific protocol table”.

### Second Embodiment

### Summary

As described above, in the vehicle-mounted network system 1000 according to the second embodiment, the communication protocol issue device 103 can store and manage vehicle-specific protocol information used by all the vehicle-mounted ECUs connected to the vehicle-mounted network 202. This management form does not use an external server or the like that collectively stores information on all the vehicles as in PTL 1. This control form is configured as distributed control in which each vehicle individually retains the vehicle's own identification information. Therefore, this management form is robust as an information management form. Even if the communication protocol issue device 103 of an individual vehicle is broken, a security crisis does not affect all the vehicles.

In addition, in the vehicle-mounted network system 1000 according to the second embodiment, when allowing the target ECU 101 to participate in the vehicle-mounted network 202, it is possible to receive assistance from the trustworthy network registration device 102 to safely share the vehicle-specific protocol among sketching control devices. This makes it possible to minimize a risk of the vehicle-specific protocol information leaking to outside.

In addition, the vehicle-mounted network system 1000 according to the second embodiment uses neither advanced encrypted communication (general common key encryption or public key encryption) nor common key distribution technique (KPS system, etc.) for a purpose of confidential communication as in PTL 1. Therefore, the vehicle-mounted network system 1000 does not additionally consume a calculation resource of CPU/ROM/RAM in the current ECU, and does not increase an implementation cost for a current situation.

As described above, in order to simply add a confidential communication function to a current network system and prevent wiretapping from and information leakage to outside, the vehicle-mounted network system 1000 according to the present invention can be called as a system that is most excellent in cost performance at this time.

### Third Embodiment

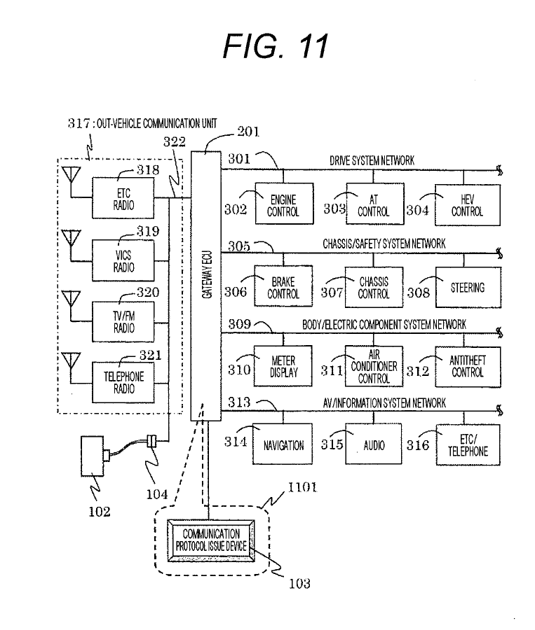

FIG. 11 is a diagram illustrating an example of a network topology of a vehicle-mounted network provided in a recent representative sophisticated vehicle. A configuration and operation of a network registration device (served concurrently by a software-rewriting device) 102, a communication protocol issue device 103, and each ECU are similar to those in the first to second embodiments.

In FIG. 11, four network groups are mounted, and each network is organized by a communication gateway (gateway ECU) 201. In FIG. 11, a star type network arrangement is employed about the gateway ECU 201, but a plurality of gateway ECUs 201 may be provided to employ a cascade connection form.

The vehicle-mounted network illustrated in FIG. 11 is mounted with a drive system network 301, a chassis/safety system network 305, a body/electric component system network 309, and an AV/information system network 313.

Under control of the drive system network 301, an engine control ECU 302, an AT (Automatic Transmission) control ECU 303, and an HEV (Hybrid Electric Vehicle) control ECU 304 are connected. Under control of the chassis/safety system network 305, a brake control ECU 306, a chassis control ECU 307, and a steering control ECU 308 are connected. Under control of the body/electric component system network 309, a meter display ECU 310, an air conditioner control ECU 311, and an antitheft control ECU 312 are connected. Under control of the AV/information system network 313, a navigation ECU 314, an audio ECU 315, and an ETC/phone ECU 316 are connected.

In addition, an out-vehicle communication unit 317 is connected to the gateway ECU 201 via an out-vehicle information network 322 in order to exchange information between the vehicle and the outside. The out-vehicle communication unit 317 is connected with an ETC radio 318, a VICS (Vehicle Information and Communication System) radio 319, a TV/FM radio 320, and a telephone radio 321.

The network registration device 102 is configured to connect as one node of the out-vehicle information network 322 via a connection vehicle connector 104 provided in the vehicle. Instead, the network registration device 102 may be solely connected to other networks (the drive system network 301, the chassis/safety system network 305, the body/electric component system network 309, and the AV/information system network 313) or the gateway ECU 201. That is, an electric signal is only required to reach the target ECU directly or via the gateway ECU 201 irrespective of a mechanical arrangement.

Functions of the network registration device 102 can also be performed from an out-vehicle communications network via the telephone radio 321 over the network. The above functions may include, for example, reissue application of the vehicle-specific protocol to the communication protocol issue device 103, a re-storing instruction of the vehicle-specific protocol to the target ECU 101, and the like. Also in this case, a method similar to those in the first to second embodiments may be used.

A method of rewriting software of the ECU via a telephone network or the Internet is important in lowering a cost for addressing a failure such as a recall, and is expected to be usual in the future.

Therefore, by using the technique disclosed in the present invention, subsequently after this software rewriting, it is possible to remotely receive reissue of the vehicle-specific protocol of the communication protocol issue device 103, and to remotely re-register the vehicle-mounted ECU with the software rewritten into the network correctly.

The communication protocol issue device 103 is directly connected to the communication gateway ECU 201 in FIG. 11, but the communication protocol issue device 103 may be arbitrarily positioned in the network. That is, the communication protocol issue device 103 may be directly connected to another network (the drive system network 301, the chassis/safety system network 305, the body/electric component system network 309, the AV/information system network 313, and the out-vehicle information network 322) as far as electric signal connection can be secured.

However, from the following two viewpoints, it is preferable that the communication gateway ECU 201 also serves as the communication protocol issue device 103 (a dashed line 1101 in FIG. 11 illustrates this functional integration).

(1) When an authentication sequence S111 of FIG. 1 and FIG. 2 fail, communication from the network registration device 102 can be electrically disconnected from the vehicle-mounted network (the drive system network 301, the chassis/safety system network 305, the body/electric component system network 309, and the AV/information system network 313) to which the target ECU 101 belongs. With such a configuration, a so-called firewall (fire-protection wall) function is given to the communication gateway 201, and thus a risk of external invasion into the vehicle-mounted network is reduced, thereby further enhancing security.

(2) An act of removing the communication protocol issue device 103 from the vehicle-mounted network for a purpose of unauthorized modification of the vehicle or falsification of a specific vehicle-mounted ECU must be prevented. For this purpose, it is preferable that the communication gateway ECU 201 and the communication protocol issue device 103 are functionally integrated to be one ECU. This is because, when the communication protocol issue device 103 is removed, it is impossible to perform mutual communication over the plurality of vehicle-mounted networks.

The invention made by the present inventor has been specifically described above by way of the embodiments, but the present invention is not limited to the embodiments and may be variously modified without departing from the spirit of the invention. For example, in the second embodiment, CAN has been mentioned as an example of a communication protocol, but another communication protocol that returns an ACK response can also be used. For example, TCP/IP (Transmission Control Protocol/Internet Protocol) in the Ethernet (registered trademark), etc. may be used. Moreover, the present invention is applicable to a vehicle-mounted network in an electric vehicle.

Furthermore, all or part of the configurations, functions, and processing units may be realized in hardware such as an integrated circuit, or may be realized in software such as programs for realizing the respective functions executed by a processor. Information such as programs or tables for realizing the respective functions may be stored in a storage device such as a memory or a hard disk, or a storage medium such as an IC card or a DVD.

### REFERENCE SIGNS LIST

101 target ECU
102 network registration device
103 communication protocol issue device
104 connection vehicle connector
201 communication gateway
202 vehicle-mounted network
301 drive system network
302 engine control ECU
303 AT control ECU
304 HEV control ECU
305 chassis/safety system network
306 brake control ECU
307 chassis control ECU
308 steering control ECU
309 body/electric component system network
310 meter display ECU
311 air-conditioner control ECU
312 antitheft control ECU
313 AV/information system network
314 navigation ECU
315 audio ECU
316 ETC/phone ECU
317 out-vehicle communication unit
318 ETC radio
319 VICS radio
320 TV/FM radio
321 telephone radio
1000 vehicle-mounted network system
1050 vehicle-specific protocol table

1. A vehicle-mounted network system comprising:
a vehicle-mounted control device provided with a memory for storing definition data that defines a portion which is based on implementation on a vehicle-mounted network among communication protocols used on the vehicle-mounted network; and
a communication protocol issue device configured to issue the definition data to the vehicle-mounted control device,
wherein, when receiving a registration request that requests to allow the vehicle-mounted control device to participate in the vehicle-mounted network from a registration device for allowing the vehicle-mounted control device to participate in the vehicle-mounted network, after authenticating the registration device, the communication protocol issue device generates the definition data based on implementation on the vehicle-mounted network and returns the definition data to the registration device,
the registration device receives the definition data transmitted from the communication protocol issue device and requests the vehicle-mounted control device to store the received definition data in the memory, and
the vehicle-mounted control device receives the definition data from the registration device, stores the definition data in the memory, and communicates using the vehicle-mounted network in conformity with the communication protocol according to the portion defined by the definition data.

2. The vehicle-mounted network system according to claim 1, wherein, after the registration device transmits the definition data to the vehicle-mounted control device, the communication protocol issue device controls operation of the vehicle-mounted control device with respect to the vehicle-mounted network by performing broadcast transmission, to the vehicle-mounted network, of a data transmission stop command for stopping the vehicle-mounted control device transmitting data to the vehicle-mounted network.

3. The vehicle-mounted network system according to claim 2, wherein, after transmitting the data transmission stop command to the vehicle-mounted network, when detecting a vehicle-mounted control device that fails to follow the data transmission stop command, the communication protocol issue device considers that an unauthorized vehicle-mounted control device is connected to the vehicle-mounted network for a purpose of one of intervention and interference, and originates an alarm indicating a fact.

4. The vehicle-mounted network system according to claim 1, wherein, after the registration device transmits the definition data to the vehicle-mounted control device, the communication protocol issue device controls operation of the vehicle-mounted control device with respect to the vehicle-mounted network by performing broadcast transmission, to the vehicle-mounted network, of an ACK return stop command for stopping the vehicle-mounted control device returning a delivery confirmation response.

5. The vehicle-mounted network system according to claim 4, wherein, after transmitting the ACK return stop command to the vehicle-mounted network, when detecting a vehicle-mounted control device that fails to follow the ACK return stop command, the communication protocol issue device considers that an unauthorized vehicle-mounted control device is connected to the vehicle-mounted network for a purpose of wiretapping, and originates an alarm indicating a fact.

6. The vehicle-mounted network system according to claim 1, wherein the communication protocol issue device issues the definition data that defines a correspondence between an ID that defines a type of data on the vehicle-mounted network and a data name that describes a name of the type of data, and the vehicle-mounted control device communicates with the vehicle-mounted network using the ID corresponding to the type of data in accordance with the correspondence defined by the definition data.

7. The vehicle-mounted network system according to claim 1, wherein the communication protocol issue device issues the definition data that defines a correspondence between a size of data for each type of data transmitted and received on the vehicle-mounted network and a data arrangement position in a packet, and a data name that describes a name of the type of data, and the vehicle-mounted control device communicates with the vehicle-mounted network using the size and the arrangement position corresponding to the type of data in accordance with the correspondence defined by the definition data.
